(19) United States
(12) Patent Application Publication
(10) Pub. No.: US 2023/0374332 A1
(43) Pub. Date: Nov. 23, 2023

(54) METHOD FOR TUNING GLOSS OR COLOR IN PAINT FORMULATIONS

(71) Applicant: Rohm and Haas Company, Collegeville, PA (US)

(72) Inventors: James C. Bohling, Lansdale, PA (US); Ibrahim Eryazici, Phoenixville, PA (US); Philip R. Harsh, Birdsboro, PA (US); Partha S. Majumdar, Harleysville, PA (US); Mario G. L. Mirabelli, Horsham, PA (US); Edwin A. Nungesser, Horsham, PA (US); Teresa A. Phillips, Westhampton, NJ (US); Daniel A. Saucy, Harleysville, PA (US)

(21) Appl. No.: 18/029,928

(22) PCT Filed: Jun. 21, 2021
(86) PCT No.: PCT/US2021/038241

§ 371 Date: Apr. 3, 2023

Related U.S. Application Data
(63) Continuation of application No. 63/114,128, filed on Nov. 16, 2020.

(51) Int. Cl. C09D 17/00; C09D 133/04; C09D 7/65; C09D 7/40; C09D 7/80

(52) U.S. Cl. CPC C09D 17/001; C09D 133/04; C09D 7/65; C09D 7/70; C09D 7/67; C09D 7/68; C09D 7/69; C09D 7/80; C09D 17/003

(57) ABSTRACT

The present invention relates to a method for preparing a multiplicity of containers of paint from a plurality of vessels separately containing an aqueous solution of a rheology modifier, an aqueous dispersion of a colorant, an aqueous dispersion of polymer particles, and an aqueous dispersion of organic polymeric microspheres. In another embodiment, the present invention relates to a method of dispensing a colorant or an opacifying agent or an inorganic extender into separate containers partially filled with a waterborne pre-paint mixture of rheology modifier, polymer particles, and organic polymeric microspheres. The process of the present invention provides a simple and cost-effective way of preparing a wide variety of a large quantity of contained and finished paints at point-of-sale.

### BACKGROUND OF THE INVENTION

The present invention relates to a method of tuning gloss in paint formulations. The method of the present invention is useful for achieving flexibility in preparing a wide variety of paint formulations at the point-of-sale.

Public demand for paints of different glosses and performance characteristics require retail stores to maintain inventories of large varieties and quantities of cans of paint. In response to these inventory pressures, retailers have attempted to develop a point-of-sale model, where paint is manufactured at the stores. However, without the quality controls and assurances provided by trained formulators, the commercial implementation of such a model has been elusive.

U.S. Pat. No. 6,689,824 (Friel) discloses the predetermined co-addition of pre-paints of opacifying pigment, inorganic extender, and binder into containers to make point-of-sale paints. The scope of the invention, however, is limited to the less complex roadmarking paint formulations, which are only tinted to a limited range of colors, rather to a wide palette of colors available for architectural paint formulations.

U.S. Pat. No. 9,994,722 (Sheerin), in an effort to address the shortcomings of previous point-of-sale models, Sheerin proposes starting with prepared paints that are complete except for colorant and gloss, and adjusting the gloss and the color to more easily give paint a uniform color appearance at different glosses. Nevertheless, Sheerin's solution does not address the problem of inventory: Multiple cans of paints are still required and the only changes that are made in the final paints are to gloss and color. Moreover, the solution does not address a need for varying opacifying pigment (e.g., TiO₂) or binder type—acrylics versus styrene-acrylics versus vinyl acetates, for example—or binder concentration or the need to adjust viscosity in the final formulation, except to have more varieties of initial completely prepared paints. Accordingly, it would be an advantage in the field of point-of-sale paint preparation to develop an easy and versatile method of preparing a wide variety of paints at the point of sale that dramatically reduced, or even eliminated the need for an inventory of containers of paint.

### SUMMARY OF THE INVENTION

The present invention has addressed a need in the art by providing a method comprising the steps of:
a) preparing a first paint by adding an opacifying pigment, a colorant, or an inorganic extender to a first container partially filled with a first waterborne pre-paint mixture of a rheology modifier, polymer particles having a z average particle size in the range of from 50 nm to 600 nm, and organic polymeric microspheres having a median weight average (D₅₀) particle size in the range of from 0.7 μto 30 μm; and
b) preparing a second paint by adding the opacifying pigment, the colorant, or the inorganic extender to a second container partially filled with a second waterborne pre-paint mixture of the rheology modifier, the polymer particles, and the organic polymeric microspheres;
   wherein: i) the pigment volume concentration (PVC) of the organic microspheres in the first and second paints is in the range of from 5% PVC to 80% PVC, and the PVC of the first paint attributable to the organic microspheres is at least 5 PVC units different from the PVC of the second paint attributable to the organic microsphere; and/or ii) the colorant in the first paint is different from the colorant in the second paint; with the proviso that when colorant is added to a container, sufficient rheology modifier is separately added to the container to produce a KU viscosity in the final paint in the range of 85 to 115 Krebbs units.

In a second aspect, the present invention is a method of tuning gloss in paint formulations at point-of-sale comprising the steps of:
a) preparing a first paint at point-of-sale by dispensing into a first container, in any order or concurrently:
   i) an aqueous solution of a rheology modifier, from a first vessel;
   ii) an aqueous dispersion of colorant, from a second vessel;
   iii) an aqueous dispersion of polymer particles having a z-average particle size in the range of from 50 nm to 600 nm, from a third vessel; and
   iv) an aqueous dispersion of organic polymeric microspheres having a median weight average (D₅₀) particle size in the range of from 0.7 μm to 30 μm, from a fourth vessel; and
b) preparing a second paint at point-of-sale by dispensing into a second container, the rheology modifier, the colorant, the polymer particles, and the organic polymeric microspheres;
   wherein: i) the pigment volume concentration (PVC) of the organic microspheres in the first and second paints is in the range of from 5% PVC to 80% PVC, and the PVC of the first paint attributable to the organic microspheres is at least 5 PVC units different from the PVC of the second paint attributable to the organic microsphere; and/or ii) the colorant in the first paint is different from the colorant in the second paint.

The method of the present invention provides a simple and cost-effective way of preparing a wide variety of paint at point-of-sale.

### DETAILED DESCRIPTION OF THE INVENTION

In a first aspect, the present invention is a method of comprising the steps of:
a) preparing a first paint by adding an opacifying pigment, a colorant, or an inorganic extender to a first container partially filled with a first waterborne pre-paint mixture of a rheology modifier, polymer particles having a z average particle size in the range of from 50 nm to 600 nm, and organic polymeric microspheres having a median weight average (D₅₀) particle size in the range of from 0.7 μm to 30 μm; and
b) preparing a second paint by adding the opacifying pigment, the colorant, or the inorganic extender to a second container partially filled with a second waterborne pre-paint mixture of the rheology modifier, the polymer particles, and the organic polymeric microspheres;
   wherein: i) the pigment volume concentration (PVC) of the organic microspheres in the first and second paints is in the range of from 5% PVC to 80% PVC, and the PVC of the first paint attributable to the organic microspheres is at least 5 PVC units different from the PVC of the second paint attributable to the organic microsphere; and/or ii) the colorant in the first paint is different from the colorant in the second paint; with the proviso that when colorant is added to a container, sufficient rheology modifier is separately added to the container to produce a KU viscosity in the final paint in the range of 85 to 115 Krebbs units.

Examples of suitable rheology modifiers in the pre-paint mixtures include hydrophobically modified ethylene oxide urethane polymers (HEURs); hydrophobically modified alkali swellable emulsion (HASEs); alkali swellable emulsions (ASEs); and hydroxyethyl cellulosics (HECs), and hydrophobically modified hydroxyethyl cellulosic (HMHECs); and combinations thereof. If more than one rheology is desired, it is advantageous to use one or more additional vessels to control the amounts of the different rheology modifiers independently. The amount of the solution of the rheology modifier used in the pre-paint mixture is readily predetermined to achieve the desired viscosity of the final untinted paint.

The polymer particles (latex particles) in the pre-paint mixtures have a z-average particle size by dynamic light scattering in the range of preferably 50 nm to 600 nm. Examples of suitable latex particles include acrylic, styrene-acrylic, urethane, alkyd, and vinyl ester (e.g., vinyl acetate and vinyl versatate) latex particles and combinations thereof. Acrylic and styrene-acrylic latex particles typically have a z-average particle size in the range of from 70 nm to 300 nm, while vinyl ester latex particles generally have a z-average particle size in the range of from 300 nm to 550 nm as measured using dynamic light scattering. The pre-paint mixtures may contain more than one class of latex particles.

Acrylic latex particles are preferably functionalized with methyl methacrylate and one or more acrylates selected from the group consisting of methyl acrylate, ethyl acrylate, n-butyl acrylate, 2-ethylhexyl acrylate, and 2-propylheptyl acrylate. As used herein, the term “structural unit” of a recited monomer refers to the remnant of the monomer after polymerization. For example, a structural unit of n-butyl acrylate is as illustrated:

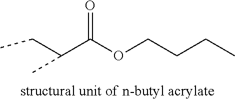

where the dotted lines represent the points of attachment of the structural unit to the polymer backbone.

Acrylic latexes particles also preferably comprise structural units of an acid monomer including carboxylic acid, sulfur acid, and phosphorus acid monomers, as well as salts thereof, and combinations thereof. Examples of suitable carboxylic acid monomers include methacrylic acid, acrylic acid, and itaconic acid and salts thereof; examples of suitable sulfur acid monomers include sulfoethyl methacrylate, sulfopropyl methacrylate, styrene sulfonic acid, vinyl sulfonic acid, and 2-acrylamido-2-methyl propanesulfonic acid, and salts thereof; examples of suitable phosphorus acid monomers include phosphonates and dihydrogen phosphate esters of an alcohol in which the alcohol contains or is substituted with a polymerizable vinyl or olefinic group. Preferred dihydrogen phosphate esters are phosphates of hydroxyalkyl acrylates or methacrylates, including 2-phosphoethyl methacrylate (PEM) and salts thereof.

In one embodiment of the method of the present invention, the acrylic latex particles are functionalized with a carboxylic acid monomer and a phosphorus acid monomer; in yet another embodiment, the acrylic latex particles comprise a shell with a protuberating PEM-functionalized core. The acrylic latex particles may comprise a bimodal distribution of acrylic polymer particles with a shell with a protuberating PEM-functionalized core, and acrylic polymers that do not have a protuberating core. Such bimodal dispersions and their preparation are disclosed in U.S. Pat. No. 9,920,194.

The organic polymeric microspheres have a median weight average particle size (D₅₀) in the range of from 0.7 μm, preferably from 1 μm, and more preferably from 2 μm, and most preferably from 4 μm, to 30 μm, preferably to 20 μm, more preferably to 13 μm, and most preferably to 10 μm, as measured using a Disc Centrifuge Photosedimentometer (DCP). These organic polymeric microspheres are characterized by being non-film-forming and preferably having a crosslinked low T_{g} core, that is, a crosslinked core having a T_{g}, as calculated by the Fox equation, of not greater than 25° C., more preferably not greater than 15° C., and more preferably not greater than 10° C.

The crosslinked core of the organic polymeric microspheres preferably comprises structural units of one or more monoethylenically unsaturated monomers whose homopolymers have a T_{g} of not greater than 20° C. (low T_{g} monomers) such as methyl acrylate, ethyl acrylate, n-butyl acrylate, and 2-ethylhexyl acrylate. Preferably, the crosslinked low T_{g} core comprises, based on the weight of the core, from 50, more preferably from 70, more preferably from 80, and most preferably from 90 weight percent, to preferably 99, and more preferably to 97.5 weight percent structural units of a low T_{g} monoethylenically unsaturated monomer. n-Butyl acrylate, and 2-ethylhexyl acrylate are preferred low T_{g} monoethylenically unsaturated monomers used to prepare the low T_{g} core.

The crosslinked core further comprises structural units of a multiethylenically unsaturated monomer, examples of which include allyl methacrylate, allyl acrylate, divinyl benzene, trimethylolpropane trimethacrylate, trimethylolpropane triacrylate, butylene glycol (1,3) dimethacrylate, butylene glycol (1,3) diacrylate, ethylene glycol dimethacrylate, and ethylene glycol diacrylate. The concentration of structural units of the multiethylenically unsaturated monomer in the crosslinked microspheres is preferably in the range of from 1, more preferably from 2 weight percent, to 9, more preferably to 8, and most preferably to 6 weight percent, based on the weight of the core.

The crosslinked polymeric core is preferably clad with high a T_{g} shell, that is, a shell having a T_{g} of at least 50° C., more preferably at least 70° C., and most preferably at least 90° C. The shell preferably comprises structural units of monomers whose homopolymers have a T_{g} greater than 70° C. (high T_{g} monomers), such as methyl methacrylate, styrene, isobornyl methacrylate, cyclohexyl methacrylate, and t-butyl methacrylate. The high T_{g} shell preferably comprises at least 90 weight percent structural units of methyl methacrylate.

The organic polymeric microspheres, preferably microspheres comprising a crosslinked low T_{g} core clad with a high T_{g} shell, may further comprise, based on the weight of the microspheres, from 0.05 to 5 percent structural units of a polymerizable organic phosphate represented by the structure of Formula I:

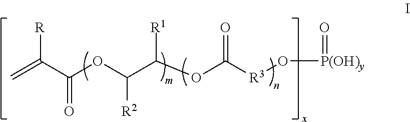

or a salt thereof; wherein R is H or CH₃, wherein R¹ and R² are each independently H or CH₃, with the proviso that CR²CR¹ is not C(CH₃)C(CH₃); each R³ is independently linear or branched C₂-C₆ alkylene; m is from 1 to 10; n is from 0 to 5; with the proviso that when m is 1, then n is from 1 to 5; x is 1 or 2; and y is 1 or 2; and x+y=3.

When n is 0, x is 1, and y is 2, the polymerizable organic phosphate or salt thereof is represented by the structure of Formula II:

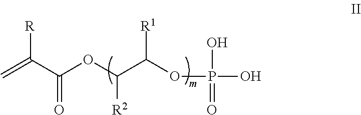

Preferably, each R¹ is H, and each R² is H or CH₃; m is preferably from 3, and more preferably from 4; to preferably to 8, and more preferably to 7. Sipomer PAM-100, Sipomer PAM-200 and Sipomer PAM-600 phosphate esters are examples of commercially available compounds within the scope of the compound of Formula II.

Where n is 1; m is 1; R is CH₃; R¹ and R² are each H; R³ is —(CH₂)₅—; x is 1 or 2; y is 1 or 2; and x+y=3, the polymerizable organic phosphate or salt thereof is represented by the structure of Formula III:

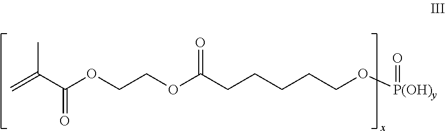

A commercially available compound within the scope of Formula III is Kayamer PM-21 phosphate ester.

The organic polymeric microspheres may also comprise 0.05 to 5 weight percent, based on the weight of the microspheres, structural units of an ethylene oxide salt of a distyryl or a tristyryl phenol represented by the structure of Formula IV:

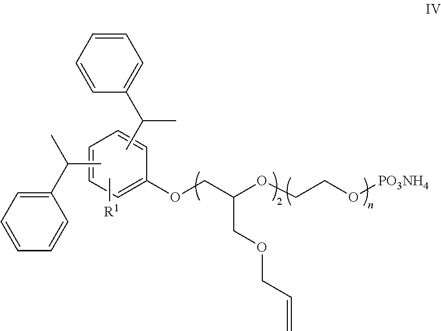

where R¹ is H, CH₂CR═CH₂, CH═CHCH₃, or 1-phenethyl; R is C₁-C₄-alkyl; and n is 12 to 18. A commercial example of the structure of Formula IV is E-Sperse RS-1684 reactive surfactant.

The organic polymeric microspheres are distinct from opaque polymers, which comprise water-containing cores that form voided polymer particles after application of the dispersion onto a substrate, followed by evaporation.

In one aspect of the present invention, an opacifying pigment, a colorant, or an extender is added to the first and second containers. The opacifying pigment, the colorant, or the extender added to the second container may be, but need not be the same opacifying pigment, colorant, or extender as added to the first container. Moreover, combinations of pigments, colorants, and extenders can be added to the first and second containers.

Suitable opacifying pigments are inorganic opacifying pigments having a refractive index of greater than 1.90, including TiO₂ and ZnO, with TiO₂ being preferred. The PVC of the TiO₂ is tunable to the desired brightness level. Other opacifying pigments include organic opacifying pigments such as opaque polymers, which may be used as a replacement for or as a supplement to inorganic pigments; if used as a supplement, the organic opacifying pigments and are advantageously added to the paint containers from a separate vessel. ROPAQUE™ ULTRA Opaque Polymers and AQACell HIDE 6299 Opaque Polymers are commercial examples of opaque polymers.

The colorant is a non-white colorant and may be organic or inorganic. Examples of organic colorants include phthalocyanine blue, phthalocyanine green, monoarylide yellow, diarylide yellow, benzimidazolone yellow, heterocyclic yellow, quinacridone magenta, quinacridone violet, organic reds, including metallized azo reds and nonmetallized azo reds. Inorganic colorants include carbon black, lampblack, black iron oxide, yellow iron oxide, brown iron oxide, and red iron oxide. In one aspect of the invention, the paints prepared by the process of the present invention are deep base paints wherein the concentration of the colorant is in the range of from 5, preferably from 8, more preferably from 10 weight percent, to 25, more preferably to 20 weight percent, based on the weight of the paints. Deep base paints comprise a substantial absence of opacifying pigment and inorganic extender; that is, they comprise less than 10 PVC, preferably less than 5 PVC, more preferably less than 1 PVC, and most preferably 0 PVC of any opacifying pigments and inorganic extenders.

When colorant is added to a pre-paint admixture, rheology modifier is added from a separate vessel in a sufficient amount to maintain a KU viscosity within the range of from 85 to 115 Krebs Units.

Suitable inorganic extenders include talc, clay, mica, sericite, CaCO₃, nepheline syenite, feldspar, wollastonite, kaolinite, dicalcium phosphate, and diatomaceous earth. Although the process of the present invention allows for the addition of extenders, it is preferred that the addition of these extenders be limited so that their PVC contribution is not greater than 20 PVC, more preferably not greater than 10 PVC, and most preferably not greater than 5 PVC; it is further preferred that the PVC contribution from the inorganic extender not exceed the PVC contribution of the microspheres. Inorganic extenders require labor and energy intensive processes including extraction from natural deposit sites and refinement into powders having broad particle sizes and shapes. The high density powders are then transported to coating manufacturing plants for further high energy grinding to de-aggregate particles into useful primary particle sizes. The resultant inorganic extenders are high surface area materials with varying surface shapes and surface energies requiring specialized formulating with binders, thickeners, and additives to overcome the quality control challenges inherent in the extraction-refinement-grinding processes. Thus, reliance on inorganic extenders to produce a multiplicity of paints in a point-of-sale model, even at a single sheen, creates a logistical roadblock for the successful implementation of such a model.

In contrast, the polymeric organic microspheres used in the pre-paints of the process of the present invention avoid the complexities associated with inorganic extenders. Polymeric microspheres can readily be prepared with uniform shape at a desired size and surface energy, thereby providing ease and consistency to the paint manufacturing processes.

The pre-paint admixtures advantageously further include one or more components such as defoamers, surfactants, biocides, coalescents, dispersants, other polymeric organic microspheres, and other latex particles.

Microsphere PVC is calculated in accordance with the following formula:

$$Microsphere PVC = [ \frac{Vol Microspheres}{Vol Opacifying Pigment + Extender + Binder} ] \times 100$$

where binder refers to the contribution of polymer from the aqueous dispersion of the polymer particles that bind the pigment and extender particles together, and extender refers to the volume of non-opacifying extenders, including polymeric organic microspheres and inorganic extenders.

In one aspect of the present invention, the PVC of the organic microspheres is different in a second container by at least 5 PVC units. As used herein, “5 PVC units” refers to the difference in percent contribution of organic microspheres between the paints; for example, the difference between 10% PVC and 15% PVC is a difference of 5 PVC units. It is understood that the process of the present invention is useful in the preparation for as many containers of paint as is desired and for any desired PVC, provided that there is a difference of at least 5 PVC units between a first container of a pre-paint and at least one other container of another pre-paint. Thus, the preparation of a second paint in a second container refers to another container following, but not necessarily directly following, the preparation of paint in a first container.

Significantly, the KU viscosity of the second paint is readily tunable to substantially the same KU viscosity the first paint. More particularly, it is preferred that the difference in KU viscosity (ΔKU) between the pre-paint admixture before colorant is added and the final paint after the colorant is added is less than 10 KU units, more preferably less than 5 KU units. It is further preferred that the first and second containers, and all other containers that may be used in the process of paint making at point of sale, have a volume capacity of from 0.25 to 5 gal (0.95 L to 18.9 L).

In a second aspect, rheology modifier, colorant, polymer particles, and organic polymeric microspheres are added from separate vessels to prepare a first and a second paint. It is preferred in this second aspect that the prepared paints are deep base paints whereby the addition of opacifying pigment and inorganic extender is limited as described hereinabove. In this second aspect, the paints differ either in the pigment volume concentration contribution of the organic microspheres (by at least 5 PVC) or in the nature of the colorant or both.

Materials may be dispensed into the containers from vessels in a variety of ways, including with the assistance of a user interface and a controller as described in U.S. Pat. Nos. 7,695,185 and 6,969,190.

### EXAMPLES

### Intermediate Example—Preparation of Dispersion of Acrylic Microspheres

The microspheres used in the Examples and Comparative Examples (Intermediate 1) were prepared as described in US 2019/185687, Intermediate Example 2 [para 0060], and adjusted to 43.5% solids. The particle size was 8.7 μm as measured by DCP, as described in para [0063] of US 2019/185687.

Table 1 illustrates comparative and example paint formulations and KU viscosities. Examples 1 and 2 were prepared by adding ingredients to multiple containers, then sealing each container and mixing the contents for 3 min using a gyroscopic mixer. Comparative Example 1 and 2 paints were mixed using an overhead stirrer. In each example, Binder refers to EVOQUE™ 3390 All Acrylic Binder; Defoamer refers to Byk-024 Defoamer; RM1 refers to ACRYSOL™ RM-2020 NPR; and RM2 refers to ACRYSOL™ RM-8W. (EVOQUE and ACRYSOL are Trademarks of The Dow Chemical Company or its Affiliates.) Red refers to Colortrend 808 Red Iron Oxide Colorant; and Blue refers to Colortrend 808 Phthalo Blue Colorant.

Table 1 illustrates the deep base paint formulations. Comparative Example 1 and 2 paints were blended using an overhead stirrer for 15 min and Example 1 and 2 paints were blended using a gyroscopic mixer for 3 min.

TABLE 1
Paint Formulations

| | Comp Ex 1 | | Ex 1 | | Comp Ex 2 | | Ex 2 | |
|---|---|---|---|---|---|---|---|---|
| Materials (g) | | KU | | KU | | KU | | KU |
| Binder | 92.74 | | 92.74 | | 92.74 | | 92.74 | |
| Intermediate 1 | 43.91 | | 43.91 | | 43.91 | | 43.91 | |
| Defoamer | 0.18 | | 0.18 | | 0.18 | | 0.18 | |
| RM1 | 2.40 | | 2.40 | | 2.40 | | 2.40 | |
| RM2 | 0.41 | | 2.05 | | 0.41 | | 2.90 | |
| Water | 17.67 | | 17.67 | | 17.67 | | 17.67 | |
| | | 108.5 | | | | 110.1 | | |
| Red | 32.38 | | 32.38 | | | | | |
| Blue | | | | | 21.37 | | 21.37 | |
| | | 73.6 | | 111.3 | | 64.7 | | 113.5 |
| Total | 189.69 | | 191.33 | | 178.68 | | 181.17 | |
| wt. % Colorants | 17.07 | | 16.92 | | 11.96 | | 11.80 | |

The comparative example deep base paints simulate the addition of colorant to fully formulated paints at point of sale. In such a model, the paint experiences a dramatic drop in KU, which cannot be further adjusted. The example deep base paints, on the other hand, which contain all of the ingredients, including colorant and adjusted rheology modifier, produces paints of constant and acceptable viscosity.

1. A method comprising the steps of: a) preparing a first paint by adding an opacifying pigment, a colorant, or an inorganic extender to a first container partially filled with a first waterborne pre-paint mixture of a rheology modifier, polymer particles having a z average particle size in the range of from 50 nm to 600 nm, and organic polymeric microspheres having a median weight average (D₅₀) particle size in the range of from 0.7 μm to 30 μm; and
b) preparing a second paint by adding the opacifying pigment, the colorant, or the inorganic extender to a second container partially filled with a second waterborne pre-paint mixture of the rheology modifier, the polymer particles, and the organic polymeric microspheres;
wherein: i) the pigment volume concentration (PVC) of the organic microspheres in the first and second paints is in the range of from 5% PVC to 80% PVC, and the PVC of the first paint attributable to the organic microspheres is at least 5 PVC units different from the PVC of the second paint attributable to the organic microsphere; and/or ii) the colorant in the first paint is different from the colorant in the second paint; with the proviso that when colorant is added to a container, sufficient rheology modifier is separately added to the container to produce a KU viscosity in the final paint in the range of 85 to 115 Krebbs units.

2. The method of claim 1 wherein colorant is added to the first container and the second container and sufficient rheology modifier is added to each of the first and second containers to produce a KU viscosity in the final paint in the range of 85 to 115 Krebbs units.

3. The method of claim 2 wherein the colorant is added at a sufficient level to achieve a concentration of from 5 to 25 weight percent in each of the first and second paints.

4. The method of claim 3 wherein the pigment volume concentration of opacifying pigments and inorganic extenders in the paints is less than 5 PVC.

5. The method of claim 2 wherein the first and the second paints have a difference in pigment volume concentration attributable to the organic microspheres that is at least 5 PVC units.

6. The method of claim 2 wherein the colorant in the first paint is different than the colorant in the second paint.

7. The method of claim 2 wherein the difference in KU viscosity between the waterborne pre-paint mixtures and the paints is less than 10 Krebbs units.

8. The method of claim 7 wherein the difference in KU viscosity between the waterborne pre-paint mixtures and the paints is less than 5 Krebbs units.

9. A method comprising the steps of:
a) preparing a first paint at point-of-sale by dispensing into a first container, in any order or concurrently:
i) an aqueous solution of a rheology modifier, from a first vessel;
ii) an aqueous dispersion of colorant, from a second vessel;
iii) an aqueous dispersion of polymer particles having a z-average particle size in the range of from 50 nm to 600 nm, from a third vessel; and
iv) an aqueous dispersion of organic polymeric microspheres having a median weight average (D₅₀) particle size in the range of from 0.7 μm to 30 μm, from a fourth vessel; and
b) preparing a second paint at point-of-sale by dispensing into a second container, the rheology modifier, the colorant, the polymer particles, and the organic polymeric microspheres;
wherein: i) the pigment volume concentration (PVC) of the organic microspheres in the first and second paints is in the range of from 5% PVC to 80% PVC, and the PVC of the first paint attributable to the organic microspheres is at least 5 PVC units different from the PVC of the second paint attributable to the organic microsphere; and/or ii) the colorant in the first paint is different from the colorant in the second paint.

10. The method of claim 9 wherein the PVC of the organic microspheres in the first and second paints is in the range of from 5% PVC to 80% PVC, and the PVC of the first paint attributable to the organic microspheres is at least 5 PVC units different from the PVC of the second paint attributable to the organic microsphere.

11. The method claim 9 wherein the colorant in the first paint is different than the colorant in the second paint.
